(19) United States
(12) Patent Application Publication
(10) Pub. No.: US 2012/0017546 A1
(43) Pub. Date: Jan. 26, 2012

(54) APPARATUS AND METHOD TO PREVENT BOTTLE ROTATION

(76) Inventor: MICHAEL H. PERONEK, Brunswick, OH (US)

(21) Appl. No.: 13/185,569

(22) Filed: Jul. 19, 2011

Related U.S. Application Data
(60) Provisional application No. 61/366,254, filed on Jul. 21, 2010.

(51) Int. Cl. B67B 3/20

(52) U.S. Cl. 53/490; 53/317

(57) ABSTRACT

A bottle support plate for use in a rotary capping machine to apply caps onto the upper threaded neck of one or more containers having a circular flange as the containers are moved along a generally circular path by a star wheel. The bottle support plate includes a pocket that at least partially supports and at least partially mates with the flange of the container to at least partially inhibit rotation of the container during the threading of a cap on an upper threaded neck of the container. The pocket includes a support ledge having an upper surface, a neck cavity, a ledge wall extending upwardly from the upper surface of said support ledge and a non-smooth surface on upper surface of the support ledge. The ledge wall is designed to be at least partially mateable with at least a portion of an outer peripheral edge of the flange of the container. The neck cavity is designed to receive a portion of a neck of the container that is located below the container flange. The non-smooth surface is designed to engage a portion of the bottom surface of the bottle flange and inhibit or prevent rotation of the bottle when a cap is twisted onto the upper threaded neck of the container.

The present invention claims priority on U.S. Provisional Application Ser. No. 61/366,254 filed Jul. 21, 2010, which is incorporated herein by reference.

The present invention relates to the art of capping plastic bottles or containers as they are moved along a preselected path, and more particularly to an improvement in a capping machine which prevents rotation of the plastic bottle or container while a cap is being tightened onto the neck of the bottle. The invention is particularly applicable to a container guide which retains the bottles or containers in the tilling or capping machine as the bottles or containers pass through the machine and will be described with particular reference thereto.

### BACKGROUND OF THE INVENTION

Blow-molded plastic bottles for containing liquids are known and have found increasing acceptance. Such containers are accepted particularly in the beverage industry as disposable containers for use with effervescent or carbonated beverages and non-carbonated beverages. Typically, these plastic bottles have a cylindrical shape which reliably contain beverage products, can be easily handled, can be inexpensively manufactured, and have stability when filled and unfilled. Such containers have most frequently been manufactured from plastic materials such as polyethylene terephthalate (PET) by, for example, blow molding a portion of PET into a mold formed in the shape of the container. The biaxial expansion of PET by blow molding imparts rigidity and strength to the formed PET material, and blow molded PET can provide economically acceptable wall thicknesses, with clarity in relatively intricate designs, sufficient strength to contain pressures up to 100 psi and more, and resistance to gas passage that may deplete contained beverages of their carbonation.

Machines in the bottling industry for filling containers or capping containers after being filled are well known in the prior art. As defined herein, such machines are collectively referred to as bottling machines. Reference may be made to U.S. Pat. Nos. 7,681,749; 6,973,761; 6,834,478; 5,934,042; 5,826,4000; 5,816,029; 5,732,528; 4,939,890; 4,624,098; and 4,295,320, all of which are fully incorporated by reference herein for a description of applications for conventional type capping machines. For purposes herein, capping and bottling machines have the same characteristics. Such machines will not be described in detail in this specification.

Generally, a capping or filling apparatus includes a rotatable star wheel mechanism for moving the bottles or containers through the machine. The star wheel generally includes a mechanism for supporting the bottle or container which are generally arranged about the periphery of the star wheel. An in feed mechanism or conveyor is utilized to bring the bottles or containers to an entry point of the star wheel and an outfeed mechanism or conveyor is similarly mated to the rotatable star wheel mechanism to transfer the capped (or filled) bottles or containers from an exit point of the star wheel. A stationary rear guide extending generally between the entry and exit point is generally spaced radially outwardly from the neck support assembly on the rotatable star wheel. This rear guide functions to retain the bottles or containers in the individual pockets of the neck support assembly as the star wheel rotates. In a conventional capping apparatus, a turret capper head is directly over the capper star wheel and moves in synchronous rotation with the capper star wheel. In a bottle filling apparatus, a filling head is located above the capper star wheel. Either of the capper head or the filling head is driven axially downward at pre-determined periods of time to place a tightened cap onto the bottle neck or to place product within the bottle. Each capper head generally employs a clutch mechanism whereby the capper head is rotated and driven axially downward at a predetermined force and torque to tighten the cap on the bottle or container.

Within a bottling plant or facility, a single capping or filling machine is used to fill or cap many different sized bottles or containers. In the soft drink industry such size bottles can include a 6-oz., 8-oz., 10-oz, a 12-oz, a 20-oz, 0.5-liter bottle, a 1-liter bottle, a 2-liter bottle, or others. Positive control of the bottles throughout the machine is typically maintained by holding the bottles or containers by the neck at a location underneath the bottle flange. Thus, based upon a predetermined control height, all the bottles or containers will be guided, and/or be partially or fully suspended throughout the filling or capping process by the bottle neck ring. Normally, the bottle or container will be rested on or be suspended above the normal wear surface. Mounted on the basic shaft of the bottling machine is a hub which supports the mounting plate and star wheel thereon. As the shaft is rotated, the hub rotates the star wheel, thus moving bottles through the machine to accomplish the capping and filling process. Smaller star wheels include neck support assemblies integral with the hub. Larger star wheel assemblies include neck guide assemblies mounted on the star wheel. Each neck guide assembly has fingers extended therefrom and guides and/or supports the neck of the bottle or container.

In order to retain the control height for different size bottles or containers, each bottle or container requires a different size and/or shape neck support bracket and lower body guide support for the sidewall of the bottle or container. Thus, in each instance where the bottle or container size to be run is changed, it is necessary to change over different aspects of the bottling machine including those portions of the machine which are specific to the particular bottle or container size being run on the line. In a bottling plant, such a change-over requires the use of skilled labor to remove the equipment which is specific for a particular sized bottle or container and replace it with substitute equipment which is specific for a different size bottle or container. Thousands of bottles or containers pass through a bottling machine each hour. Maintaining this volume is very important to meet both consumer and industry demands as well as plant capacity. As such, the down time associated with a change-over to different size bottles or containers is a significant loss in both dollars and lost productivity due to reduced output capacity, idle manpower and the skilled work force required to complete a change-over. In order to address this problem, a modified container guide was developed and is disclosed in U.S. Pat. No. 5,732,528 which is incorporated herein by reference. U.S. Pat. No. 5,732,528 discloses an improved container guide system for a bottling machine which includes redesigned star wheel and rear container guides that enable the body guide or body star on the star wheel and the sidewall guide on the rear container guide to be capable of quick adjustment without the necessity to remove and reinstall different guides for different sized bottles. Change-over mainly requires depressing a button on each guide to release an adjustable locking mechanism and to slide the guide along a positioning rod to a desired new position. A positioning block located on the guides holds the adjustable locking mechanism and effectively moves the body guide and/or sidewall guide to its new position where the button is released to lock the guide in place. The easy adjustment also allows for quick and easy removal of the guide and replacement with another guide having the size requirements desired. This improved container guide system significantly reduces the down time of a bottling line due to a change-over. No tools are needed to effect the change over as it relates to container guides, thus a machine operator is capable of depressing the button for releasing and sliding the body guide, or body star, on the star wheel or the sidewall guide on the rear container guide to a second position where the button is released and the guide is locked into place. The improved guide system also reduces the number of parts necessary to effect a change over on a bottling line and provides a positive adjustable control guide once the initial modifications to install the invention are made to the bottling machine.

With respect to the cap or the closure, for years, the crown was the dominant closure employed on bottle or container and is still in use today in the beer industry. The crown closure eventually was partially replaced by caps or closures commonly called “roll-on” caps. This type of closure comprised a cap shell of aluminum which was inserted over the threaded neck of the bottle or container and then secured in place by rolling threads in situ into the walls of the cap shell. Capper heads which performed the rolling operation typically exerted downward forces of up to 500 pounds onto the neck of the bottle or container. This force, of course, was transmitted to the base of the bottle or container and then developed a sufficient frictional force with the capper star wheel base to prevent bottle or container rotation during the capping process. Over time, the roll-on cap was partially replaced with plastic or metal locking type, threaded caps. In the beverage industry, threaded safety caps have a frangible connection at the cap base thereof which will herein be referred to as a “lock band”. In the case of a metal cap, the capper heads simply crimped the lock band about the bottle or container neck portion beneath the lowermost thread. In the case of a plastic cap, heat is applied to the lock band of the cap after the cap is tightened onto the filled bottle or container and then shrunken to the neck of the bottle or container. Plastic caps with heated lock bands can be applied to either plastic or glass bottles or containers. In the plastic cap application, the force of the capper head is generally reduced to a downward thrust of about 50-60 pounds. This force is not sufficient to generate a sufficient frictional force at the base of the bottle or container to prevent the bottle or container from rotating in the pocket of the capper star wheel. Bottle or container rotation in the capper pocket prevented adequate cap tightening. Accordingly, several different concepts have been employed to prevent bottle rotation for plastic cap applications. For example, the bottle or container was shaped with a wedge sidewall configuration and the transfer mechanisms between the various star wheels modified to feed the bottles or container into configured pockets. Additionally, a high friction material such as polystyrene was applied to the bottom of the bottle, especially for glass bottles, so as to better grip the base of the capper star wheel and enhance the frictional, anti-rotation force. Such modifications, while functional, were not acceptable. The consuming public did not accept configured bottles. Adding friction material to the bottle or container materially increased its cost and its effectiveness was diminished in the event the base of the capper star wheel became wet or was subjected to oil, both of which are common occurrences in the operation of a bottling plant. U.S. Pat. No. 4,624,098, which is incorporated herein by reference, disclosed the use of a belt to subtends a portion of the pocket to urge the bottle or container against the rear guide thus increasing the friction between the side of the bottle or container and the rear guide which, when added to the frictional force at the base of the bottle or container, prevented bottle or container rotation during the tightening of the cap. This capping design has proven acceptable in capping applications where the downward force exerted on the bottle or container head from the capping head is as low as 50-60 pounds.

More recently, plastic, threaded safety caps or closures have been developed which do not require the application of heat to set or position the lock band. By tapering the bottle neck beneath the lowermost thread and also tapering the edge of the lock band, the lock band simply snaps in a locking position vis-a-vis the tapered fit when the cap is tightened to a predetermined position. This position occurs when the axial downward face on the cap from the capper head is about 15-20 pounds. This low capper heat axial force makes retention of the bottle or container within the pocket very difficult, even with the use of very strong elastic bands in the pocket such as disclosed in U.S. Pat. No. 4,624,098. Accordingly, the device now in conventional use for such threaded plastic caps, at least when used on plastic bottles or container is a anti-rotation device developed by Metal Box p.l.c. This device includes a capper pocket that has an arbitrarily designated forward converging surface and a rearward converging surface. The forward converging surface has backwardly facing teeth which oppose the tightening direction of rotation of the capper head. The rearward converging surface is smooth and acts, in conjunction with rear guide, as a cam surface to drive the bottle neck against the teeth of forward converging surface. This device has several limitations. For instance, the toothed anti-rotation device is limited to plastic bottle applications in which the backwardly facing teeth can grip and permanently indent the surface without fracturing the bottle or container. In glass bottles, the shock loading when the backwardly facing teeth grip the neck could result in bottle fracture. Furthermore, although the forward and rearward converging surfaces are designed to be easily replaced, the replacement cost for each capper pocket approaches several hundred dollars and is relatively expensive. In addition, the device is functionally limited. Not all bottles or containers have straight neck portions underneath the threads. Many bottle designs curve or taper the neck and when this occurs, the backwardly facing teeth make detrimental point contact with the bottle or container neck. More significantly, the diameter of the neck portions of plastic bottles or container, whether tapered or straight, typically vary from the nominal dimension. The dimensional variation means that for some bottles or containers, the neck of the bottle or container will be cocked or wrenched into point indentation contact with the backwardly facing teeth as the cap is tightened. This will mark or score the neck wall and such marking is, of course, aggravated if the neck tapers and is not straight. Since the plastic used to manufacture the bottle or container is somewhat permeable, the scoring permits the gas of a carbonated beverage within the container to more easily permeate through the plastic contributing to a “flat” beverage. More critical, though, is that the neck marking or scoring acts as a stress riser to cause an occasional bottle or container failure. This is unacceptable. Additionally, the bottle is aesthetically marred.

These problems were successfully addressed in U.S. Pat. No. 4,939,890 wherein an upwardly directed knife is used to prevent the rotation of the bottle or container during the capping process. The knife ridges on the anti-spin segment on each pocket engage the lower surface of a circular flange at the bottom of the threaded neck of a plastic bottle or container to prevent rotation of the plastic bottle. A mechanism for externally applying a downward force on the body of a bottle or container being capped, which force is independent of the downward force created by the capping operation, is used during the capping process. This anti-spin or anti-rotation mechanism has been successful. The anti-rotation device of U.S. Pat. No. 4,939,890 is the most successful arrangement for applying plastic threaded safety caps onto the top of plastic bottles or containers where the caps do not require heat to set or position the lower lock band around the neck of the bottle or container. The lock band of the cap simply snaps into a locking position when the capping head threads the cap onto the upper threaded neck of the plastic bottle or container. In this type of capping operation, the capper head exerts a downward force of between 15-20 pounds. This low axial force makes retention of the bottle from rotation within the star wheel pocket very difficult. This situation motivated the development and use of the anti-rotation feature disclosed and claimed in U.S. Pat. No. 4,939,890, which is incorporated herein by reference.

Although the capping mechanism disclosed in U.S. Pat. No. 4,939,890 addressed many of the past deficiencies of past capping mechanisms, the improved capping mechanism requires a mechanism for exerting a downward force on the bottle which is expensive and is dependent upon certain structural characteristics at the upper portion of the bottle itself. Changes in bottle configuration often require anew force exerting mechanism. In addition, the use of the knife slightly disfigured the plastic bottle or containers, thereby make the bottle or container less aesthetically pleasing to the consumer. U.S. Pat. Nos. 5,934,042; 5,826,400; 5,816,029; and 5,398,485 disclose anti-rotation mechanisms that address these issues. Both patents disclose an anti-rotation mechanism used on a capping machine, which accomplishes the results of the anti-rotation arrangement disclosed in U.S. Pat. No. 4,939,890, but do not rely upon developing downward frictional force on the top of the bottle or container during the capping operation.

The anti-rotation disclosed in U.S. Pat. Nos. 5,934,042; 5,826,400; 5,816,029; and 5,398,485, which are incorporated herein by reference, are particularly applicable for use with a plastic bottle or container having a pedaloid base (e.g., base with multiple legs), which is somewhat standard in the soft drink industry. These bases include a plurality of downwardly extending feet or pads, generally four or five, separated by diverging recesses. The plastic bottles or containers with pedaloid bases have been capped in standard machines with a lower plate rotated with the capping heads and having contoured recesses or nests directly aligned with the capping heads and pockets of the rotating star wheel. A plurality of specially contoured recesses that match the pedaloid base configuration are used to receive the bases of the bottles or containers as the bottles or containers are moved by the star wheel. Since the bottles or container rest upon the lower circular wear plate or ring and are held within a contoured nest on the plate, rotation of the bottles or containers is prevented by an interference between the lower wear plate and the bottom, or base, of the bottle or container. This arrangement is completely different from the concept of increasing the friction at the top of the bottle or container or otherwise preventing rotation of the bottle or container by frictional force. The provision of a lower circular wear plate with machined recesses, each matching the contour of a pedaloid base of the plastic bottles or container can be expensive. Each of the contoured recesses must be specially produced and accurately matched with respect to the actual shape of each pedaloid base of the bottle or container being processed. Consequently, each bottle or container required its own lower support wear plate. Indeed, when the filled bottles or container being capped are changed from a four pad pedaloid base to a five pad pedaloid base, a completely new, specially machined plate for supporting the pedaloid bases must be assembled onto the machine. This arrangement for providing a plate rotatable with the star wheel for supporting the lower pedaloid bases of the bottles or container demanded a plate which must be accurately machined for use with specific star wheels. Another anti-rotation system included an arrangement for fixing the support member or wear plate in a position spaced from the turret where the bottles or containers slide along a rib as the bottle or container is moved around the arcuate path dictated by the movement of the capping head and the star wheel. The rib extends into the lower recess of the pedaloid base of the individual bottle or container to prevent rotation of the bottle or container as the capping head drives the cap onto the upper threaded neck of the bottle or container. By using this construction, a lower support plate carrying the upstanding rib is fixed and does not rotate with the star wheel. The upwardly extending rib prevents rotation of the bottles during the capping operation. This use of a fixed rib constitutes an improvement over other arrangements for using a lower plate with specially contoured recesses to provide interference against rotation of the bottle by the capping head; however, it requires a modification of the capping machine and is expensive to retrofit.

Two anti-rotation mechanisms that overcome these past problems are disclosed in U.S. Pat. Nos. 5,934,042 and 5,816,029. These anti-rotation mechanisms use a standard wear plate of the type rotating with the star wheel of a rotary capping machine and which are adapted to accommodate cylindrical containers with an outer cylindrical periphery and a pedaloid base with spaced pads separated by radial recesses extending from a center recess of the base. In the capping machine, the bottles or containers are moved along a circular path by a star wheel that has outwardly protruding pockets supporting the necks of the bottles or containers while they are supported at the lower position by a rotating wear plate. The wear plate is a flat ring rotated in unison with the star wheel about the machine axis so the bottles or containers moving along a given circular path are carried by and supported on the wear plate. The ring constituting the wear plate has an upwardly facing flat surface with a series of container receiving nests movable along the circular path as the ring is rotated by the turret of the capping machine. Each of these nests has an inner area constituting a flat surface and at least one elongated bar-like abutment projecting upwardly from the flat surface of the ring and extending in a direction radial of the inner area of the nests. In practice, two or three of the elongated bar-like abutments project radially outwardly from the inner area defining the nest onto which a container is supported. These radially projecting abutments are faced by an angle defined as 360°/X, wherein X is a number of pads in the pedaloid base. The rib extends into the lower recess of the pedaloid base of the individual bottle or container to prevent rotation of the bottle or container as the capping head drives the cap onto the upper threaded neck of the bottle or container.

Although these prior art capping mechanisms have had excellent success in the bottling of carbonated beverages, problems with damage to the base of the plastic bottle or container has resulted when bottling non-carbonated beverages such as water, fruit drinks and the like. Most of the plastic bottles or containers used in the beverage industry are plastic bottles or containers made from blow molded polyethylene terephthalate (PET). These plastic bottles or containers include “champagne” type bases or bases having a plurality of feet to structural enhance the base of the plastic bottle or container. Much of the plastic bottle design has been directed to the carbonated bottle industry. However, the non-carbonated beverage market such as water, sport drinks, fruit drinks and the like have continued to grow. It is not uncommon that plastic bottles originally designed for carbonated beverages are used for non-carbonated beverages. However, the use of these plastic bottles or containers have been problematic, especially during the bottling of the non-carbonated beverage. The gas in carbonated beverages exerts a force on the interior of the bottle or container, thus resisting the deformation or collapse of the base of the bottle or container during the capping process. As a result, the base and walls of the plastic bottle or container can be made of a thinner material, which is a significant cost savings to the manufacturer. The absence of gas in non-carbonated beverages has resulted in increased deformation and/or damage of the base of the plastic bottle or container during the bottling process. In order to address this problem, increased wall thickness for the side walls and base of the plastic bottles or containers have been used. Although, the increased wall thickness of the plastic bottle or container reduces the incidence of deformation and/or damage of the base of the plastic bottle or container during the bottling process, the increased wall thickness translates into increased material costs. Alternatively, plastic bottles or containers that include a plastic base attachment have also been used to address this problem. However, the use of the plastic base attachment also increases the cost of the bottle or container. Bottling manufacturers that bottle both carbonated and non-carbonated beverages must now maintain additional inventory of various bottle or container configurations and thickness.

U.S. Pat. No. 7,681,749; U.S. Pat. No. 6,973,761 and U.S. Pat. No. 6,834,478 address the issues associated with potential damage to the base of the plastic bottles. U.S. Pat. No. 7,681,749; U.S. Pat. No. 6,973,761 and U.S. Pat. No. 6,834,478 dies a non-round flange that can be captured in an anti-rotation plate. Although the non-round flange is very effective in preventing rotation of the bottle during a capping process, there are industry and public adoption issues regarding the non-standard shape of the flange and issues regarding the non-round flange properly seating itself in the anti-rotation plate prior to or during the capping process.

Another aspect of the bottling process relates to conveying the bottles to and from the capping machine. As can be appreciated, large volumes of bottles must be fed to first the filling portion of the process and then later to the capping machine. Furthermore, due to the scale of these bottling operations and the sizes of the machines used therein, the conveying portion of the bottling process can be significant. Therefore, it is advantageous to provide low cost methods to convey both the unfilled and the filled bottles to and from the bottling apparatuses. As stated above, downtime can be costly which necessitates quick changeovers from one bottle size to the next or from carbonated beverages to non-carbonated beverages. As can also be appreciated, a changeover which necessitates a modification to the conveying system can be costly in both man hours used to make the changeover and loss profits for the time in which the operation is shut down. Thus, it is preferred that modifications to the conveying system be minimized from one bottle to the next.

It has been found that air powered conveyors can be used to inexpensively convey the empty bottles to the filling and capping machines. Due to the lightweight plastic materials used in the construction of these bottles, air pressure can effectively move a large number of bottles if the air is properly directed. The use of pressurized air to convey the empty bottles is disclosed in U.S. Pat. Nos. 4,284,370; 5,161,919 and 5,437,521, which are incorporated herein by reference for showing air conveying systems. However, these air conveying systems must effectively utilize the neck flange of the bottle and the outer configuration of the bottle to support and move the bottle in the desired direction. Modifications to the neck flange and/or bottle configuration can have adverse affects to the effectiveness of the conveying system. In one respect, the air power conveyor systems rely on the neck flange to support the bottle as it is conveyed. The neck flange provides a good support structure and also minimizes the frictional or drag force produced by the supporting structure of the conveying system. Thus, if the neck flange becomes disengaged from the rails of the conveying system, the bottle can become jammed or can fall from the conveying system. Therefore, it is important that the neck flange be configured to reliably maintain the engagement with the conveying rails of the air conveyor at all times to minimize downtime in the conveying process.

Yet another aspect of using an air conveying system, is the control of the pressurized air. As can be appreciated, the pressurized air will only move the bottles if it engages at least one surface of the bottle. In addition, containing the pressurized air is also a factor. Air escaping from the conveying system can reduce the efficiency of the conveyor. As a result, the tolerances between the rails of the conveying system and the outer configuration of the neck of the bottle are a factor in how well the conveyor will move a particular bottle.

In view of the present state of the art for bottling machines, there is a need for a bottling machine that can be used for carbonated and non-carbonated beverages which resists deformation and/or damage to the base and/or body of the plastic beverage container during the bottling process and which prevents rotation of the bottle during the capping process.

### SUMMARY OF THE INVENTION

The present invention provides an improved device or method for preventing rotation of a bottle or container of the type having a body with a flange below a neck on the top of the bottle or container. The invention is particularly applicable for use with a plastic bottle or container having a generally cylindrical body with a flange below a threaded neck on the top of the bottle or container. Although the invention is particularly directed to plastic bottles or containers, other types of bottles or containers can be used such as, but not limited to, metal bottles, and the like. The body of the bottle or container can have a shape other than a generally cylindrical shape. The bottle or container that can be used in the improved device or method can have a variety of shapes such as, but not limited to, a flat base, a pedaloid base, a champagne-type base, and the like. The invention is particularly applicable to the beverage industry, and more applicable to the non-carbonated beverage industry; however, the invention is equally applicable to the carbonated beverage industry. In addition, the present invention is applicable to the bottling of liquids in bottles or containers other than beverages (e.g., cleaning products, automotive products, paint products, etc.). In accordance with the present invention, there is provided a bottle support plate that at least partially supports the bottle or container at the flange below the neck of the bottle or container during the capping process. The support plate is designed to at least partially counter the axially downward force exerted on the bottle or container when the capping machine exerts a downward force on the top of the bottle or container as the cap is being applied to the bottle or container. The counter-active effect of the support plate results in a reduction or elimination of compressive force exerted on the body and/or base of the bottle or container. As a result, damage to the base and/or body of the bottle or container is reduced or eliminated during the capping process. The support plate can also or alternatively be designed to at least partially counter the axially downward force exerted on the bottle or container when the bottle or container is filled with a fluid. Depending on the flow rate of fluid into the bottle or container, the viscosity of the fluid, and/or the temperature of the fluid, the fluid can cause damage to the base of the bottle or container during the filling process. The support plate can reduce or eliminate such damage to the base of the bottle or container during the filling process by partially or fully supporting the bottle or container such the base of the bottle of the container does not bear the full load or force of the fluid during the filling process. The support plate can be made from a number of different materials that are resistant to wear and which can support the weight of the bottle or container during the capping and/or filling process. Such materials include, but are not limited to metal (e.g., stainless steel, aluminum, etc.), plastics, fiberglass, rubber, etc.

In another and/or alternative aspect of the present invention, the bottle support plate is used to partially or fully support plastic containers; however, other types of containers can be used such as, but not limited to, glass containers, metal containers, and the like. Blow-molded plastic containers for handling liquids at elevated pressures are known and have found increasing acceptance. Such containers are accepted particularly in the beverage industry as disposable containers for use with effervescent or carbonated beverages, especially carbonated soft drinks. These plastic containers can reliably contain carbonated beverages generating internal pressures as high as 100 psi or more, and can be inexpensively manufactured. Typically, these plastic containers have a cylindrical shape which reliably contain carbonated beverage products, can be easily handled, can be inexpensively manufactured, and have stability when filled and unfilled. Such containers have most frequently been manufactured from plastic materials such as polyethylene terephthalate (PET) by, for example, blow molding a portion of PET into a mold formed in the shape of the container. The biaxial expansion of PET by blow molding imparts rigidity and strength to the formed PET material, and blow molded PET can provide economically acceptable wall thicknesses, with clarity in relatively intricate designs, sufficient strength to contain pressures up to 100 psi and more, and resistance to gas passage that may deplete contained beverages of their carbonation. In one non-limiting bottle or container configuration, the bottle or container includes a cylindrical sidewall portion and a lower bottom-forming portion having a plurality of circumferentially-spaced, downwardly convex segments extending downwardly from the cylindrical sidewall and a plurality of intervening, circumferentially-spaced, totally convex, hollow foot-forming portions that extend radially from the central bottom portion and downwardly from the downwardly convex segments to form a clearance for a concave central bottom portion. In another and/or alternative bottle or container configuration, the bottle or container includes a cylindrical sidewall portion all about a central longitudinal axis, a lower bottom-forming portion including a plurality of hollow foot-forming portions extending outwardly from the central portion of the lower bottom-forming portion to form a plurality of feet, each foot-forming portion including, between the central portion of the lower bottom-forming portion and its foot, a bottom clearance-forming portion including a compound-curved offset formed by opposing radii of curvature wherein the compound-curved offset curving downwardly from the central portion about a radius of curvature below the bottom of the lower bottom-forming portion before curving about a radius of curvature above the bottom of the lower bottom-forming portion, and a plurality of smoothly curved, downwardly convex segments between adjacent pairs of hollow foot-forming portions, each of the downwardly convex segments extending upwardly between the adjacent hollow foot-forming portions and, generally expanding outwardly at its upper end to merge into the cylindrical sidewall portion. In another and/or alternative aspect of this embodiment, the lower bottom-forming portion includes a plurality of ribs extending from the sidewall to a central portion of the lower bottom-forming portion where the ribs intersect. The upper curvilinear surface of the ribs lies on an essentially hemispherical curve in the interior of the container. In one design of this aspect, the lower bottom-forming portion includes a plurality of uniquely designed feet which extend along a curved path from the sidewall, have end walls connected to adjacent ribs and include a generally horizontal base surface. This configuration of the lower bottom-forming portion depicts a pseudo-champagne appearance wherein the feet contain a substantially vertical inner surface or lip positioned radially inwardly from the base surface and connected to a second inner surface which extends from the substantially vertical lip to the central portion of the bottom structure. Thus, the inner surfaces of the feet define a pseudo-champagne dome below the central portion and below the hemispherical bottom contour defined by the upper rib surfaces. In yet another and/or alternative aspect of this embodiment, the lower bottom-forming portion includes an essentially hemispherical curve in the interior of the container. This configuration of the lower bottom-forming portion depicts a champagne appearance. In still another and/or alternative embodiment of the invention, the plastic container includes an upper mouth-forming portion adapted to receive a fluid and a cap to cover the upper mouth. The design and configuration of the mouth opening can be generally the same as used in prior art plastic bottles used for carbonated beverages; however, it can be different. In one aspect of this embodiment, the opening in the upper mouth-forming portion is substantially circular. In another and/or alternative aspect of this embodiment, the upper mouth-forming portion includes one or more threads that are adapted to receive a cap. The one or more threads have a configuration that is generally the same as the threads used on prior art bottles; however, it can be different. Several of these bottles are disclosed in U.S. Pat. Nos. 4,120,135; 4,978,015; 4,939,890; 5,398,485; 5,603,423; 5,816,029; 5,826,400; 5,934,024; and 6,276,546. The bottles disclosed in these patents are fully incorporated herein by reference to illustrate some examples of the type and shape of bottles that can be used in the present invention. As can be appreciated, other types of plastic can be used to form the plastic container. As can further be appreciated, these plastic containers and others can be used to contain fluids other than beverages (e.g., food products other than beverages, cleaning products, automotive products, paint products, etc.).

In another and/or alternative aspect of the present invention, the support plate at least partially supports the bottle or container during the capping process thereby countering most, if not all, of the downward force being applied to the top of the bottle or container during the capping process. In one embodiment, the support plate fully supports the container during the capping process, thereby countering most, if not all, of the downward force being applied to the top of the container during the capping process. In another and/or alternative embodiment of the invention, the support plate fully supports the container during the liquid filling process, thereby countering most, if not all, of the downward force being applied to the container during the fluid filling process. In still another and/or alternative embodiment of the invention, the support plate is designed so that the portion of the bottle or container below the flange does not engage the support plate when the support plate is at least partially supporting the bottle or container. As such, the support plate is designed to only contact the bottle flange when the flange is properly positioned in the support plate and a cap is applied to the bottle. This configuration of the support plate is unique from the support plate disclosed in U.S. Pat. No. 6,834,478 and U.S. Pat. No. 7,681,749 wherein the support plate is configured so that the bottle portion below the flange contacts the support plate and helps position the bottle in the support plate. The support plate is designed so as to not rely upon any portion of the bottle except the bottle flange to position the bottle in the support plate. It has been found that the region of a blown plastic bottle can slightly vary. The flange of the bottle generally is consistent to within one or two thousandths of an inch; however, the region below the bottle flange can vary to within several hundredths of an inch. Although the size variation in the region below the bottle flange is generally small, such variation can cause line interruptions resulting from the bottle not being properly positioned during the capping process. Current bottling machines require the bottle to be accurately positioned under the capping device or the capping device will stop the bottling line. In an effort to address this problem, the support plate of the present invention is designed to engage only the flange of the bottle and to position the bottle relative to the support plate solely on the bottle flange. Due to the highly consistent bottle flange size, the problems associated with improper bottle positioning is significantly reduced or eliminated by the support plate of the present invention. In one aspect of this embodiment, the landing or support ledge of the support plate includes a side opening adapted to at least partially receive a portion of the flange of the bottle or container. In one particular non-limiting design, the opening in the landing or support ledge is a generally C-shaped configuration; however, other shaped openings can be used to form shapes other than a C-shape. The C-shape configuration is generally used for bottles or containers having a generally circular flange. The landing or support ledge is generally sized so as to support the bottle or container on the bottom surface of the flange, but not engage the portion of the bottle below the flange; however, this is not required. The shape of the landing or support ledge with included support plate is non-limiting. In one particular non-limiting design, the landing or support ledge has a generally C-shaped configuration when the shape of the bottle or container beneath the flange is generally circular; however, other shapes for the landing or support ledge can be used. In another or additional non-limiting design, the configuration of the landing or support ledge is sized so as to inhibit or prevent the flange of the bottle or container from passing through the landing or support ledge when the bottle or container is being filled and/or capped. In still another and/or additional non-limiting design, the configuration of the landing or support ledge is shaped and sized so that less than about 50% of the perimeter of the bottle portion beneath the flange is encircled by the landing or support ledge.

In still another and/or alternative aspect of the present invention, the bottle support plate includes one or more friction engagements that are adapted to at least partially engage the bottom surface of the flange of the bottle or container to inhibit or prevent the bottle or container from rotating when a cap is applied to the cap of the bottle or container during the capping process. The one or more friction engagements effectively inhibit or prevent rotation of a bottle or container when the one or more friction engagements engage the bottom surface of the flange of the bottle or container. In one non-limiting arrangement, one or more friction engagements include a rib, sharp raised implement, non-smooth surface, etc. that engages and inhibits or prevents rotation of a bottle or container during the capping process. In another and/or alternative non-limiting arrangement, there is provided a plurality of friction engagements on the bottle support. In one non-limiting configuration, the friction engagements are evenly spaced apart in the bottle support.

In yet another and/or alternative aspect of the present invention, the bottle support plate includes a support ledge that is recessed from the top surface of the bottle support plate. The recess provides a space to allow the capping mechanism to insert a cap on the container without having to contact the bottle support plate. As can be appreciated, the recess in the bottle support plate is not required. In one embodiment, the recess has a semi-circular shape to accommodate the shape of the capping mechanism. As can be appreciated, other shapes of the recess can be used.

In still yet another and/or alternative aspect of the present invention, the bottle support plate is removably connected to the bottling and/or capping mechanism. Bottling machines commonly include a rotatable star wheel and a rear container guide assembly spaced radially outwardly from the rotatable star wheel to retain the container within the rotatable star wheel. The rotatable star wheel typically includes a hub secured to a vertically extending drive shaft which rotates about a drive shaft axis. Extending radially outwardly from the hub are typically one or more bottle support assemblies. Each bottle support assembly is mounted on the star wheel. The bottle support plate is designed to be removably connected to one or more of the bottle support assemblies. The ability to remove the bottle support plate from the bottle support assembly results in 1) easier repair and/or replacement of a damaged bottle support plate, 2) less down time for the repair and/or replacement of a damaged bottle support plate, and/or 3) the ability to quickly and easily change out one or more bottle support plates to accommodate a certain type of container. In one embodiment, the bottle support plate is connected to the bottle support assembly by use of, but not limited to, bolts, screws, pins, adhesives, clamps, latches, nails, and the like. As can be appreciated, the bottle support plate can be essentially irremovably connected to the bottle support assembly. If such a connection is desired, it can be accomplished by a variety of means such as, but not limited to, welding, soldering, bolts, screws, pins, rivets, adhesives, clamps, latches, nails, and the like.

One non-limiting object of the present invention is to provide a bottling and/or capping mechanism that reduces or prevents damage to a container during the capping and/or tilling of the container.

Another and/or alternative object of the present invention is to provide a bottling and/or capping mechanism that includes a support plate that at least partially engages a flange of a bottle or container while not engaging the portion of the bottle or container below the flange, thereby ensuring properly positioning of the bottle or container beneath a capping machine during the capping process.

Still another and/or alternative object of the present invention is to provide a bottling and/or capping mechanism that can be used to fill and cap containers with non-carbonated fluids and/or carbonated fluids.

Yet another and/or alternative object of the present invention is to provide a bottling and/or capping mechanism that includes a removable support plate.

Still yet another and/or alternative object of the present invention is to provide a support plate that can be used on existing bottling and/or capping mechanisms.

A further and/or alternative object of the present invention is to provide a mechanism for inhibiting or preventing container rotation in a bottling and/or capping machine which is operable on plastic bottles or containers.

Still a further and/or alternative object of the present invention is to provide an anti-rotation device in a bottling and/or capping machine which does not cause failure or damage to the body of the bottle or container below the flange.

Yet a further and/or alternative object of the present invention is to provide an economical, easily replaceable mechanism for preventing container rotation in a bottling and/or capping machine.

These and other advantages will become apparent to those skilled in the art upon the reading and following of this description taken together with the accompanying drawings.

### BRIEF DESCRIPTION OF THE DRAWINGS

Reference may now be made to the drawings, which illustrate various embodiments that the invention may take in physical form and in certain parts and arrangements of parts wherein:

FIG. 1 is a partial plan view of a bottling machine employing the container guide assembly of the present invention;

FIG. 2 is a cross-sectional elevation view taken along line 2-2 of FIG. 1;

FIG. 3 is a top elevation view of a star wheel that includes the bottle supports in accordance with the present invention;

FIG. 4 is a bottom plan view of bottle support plate in accordance with the present invention;

FIG. 5 is a top plan view of bottle support plate in accordance with the present invention;

FIG. 6 is a partial cross-section view of the star wheel of FIG. 3 and illustrating a bottle being supported by the bottle support plate in accordance with the present invention;

FIG. 7 is an elevation view of the anti-rotation plate in accordance with the present invention;

FIG. 8 is an exploded view of the anti-rotation plate of FIG. 7;

FIG. 9 is a side view of a bottle being supported by the anti-rotation plate in accordance with the present invention;

FIG. 10 is a perspective view of an air-powered bottle conveying system;

FIG. 11 is a sectioned elevation view of the conveying system shown in FIG. 8;

FIG. 12 is a partial sectioned elevation view of the conveyor shown in FIG. 8 wherein the plastic bottle is canted; and,

FIG. 13 is an enlarged partial sectional view showing the engagement between the bottle flange and the rails of the conveying system.

### DETAILED DESCRIPTION OF THE INVENTION

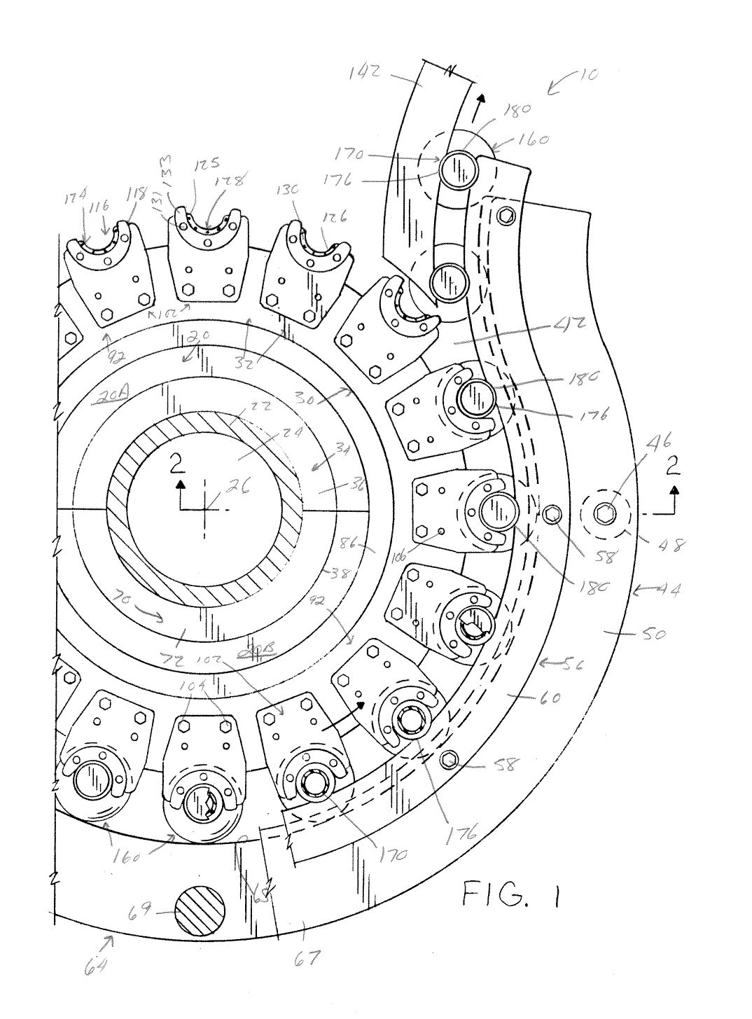

Referring now to the drawings wherein the showing is for the purpose of illustrating preferred embodiments of the invention only and not for the purpose of limiting the same, FIGS. 1-3 illustrate various portions of what is defined as a bottling machine 10. The bottling machine as defined herein includes the tilling and/or the capping bottling equipment. The filling equipment is that which tills containers with product, such as, but not limited to, a non-carbonated beverage. The capping equipment is that which applies a cap, crown or other closure to the container.

Bottling machine 10 includes a rotatable star wheel 20 and a rear container guide assembly 40 spaced radially outwardly from rotatable star wheel 20 for retaining the bottles 160 within rotatable star wheel 20. Depending upon the application of bottling machine 10, an additional star wheel (not shown) or conveyor (not shown) is mated to rotatable star wheel 20 at a fixed entry point (not shown) on rotatable star wheel 20. Bottles 160 are rotated out of rotatable star wheel 20 at a fixed exit point 42 to an outfeed star wheel (not shown) or conveyor (not shown) leading to further processing or handling equipment.

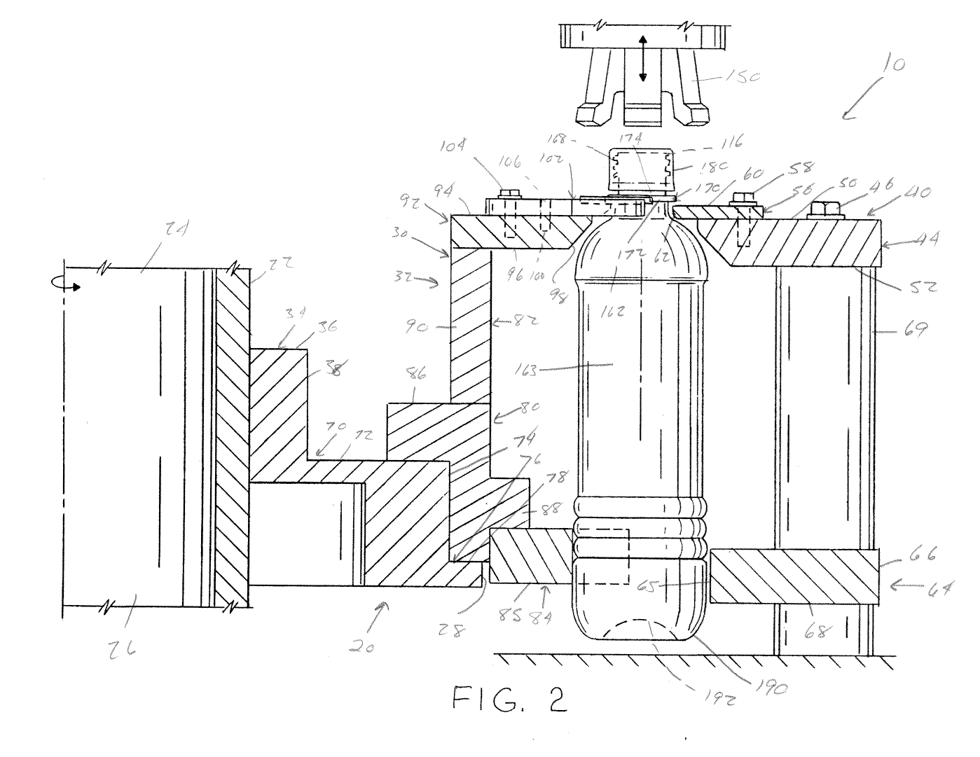

FIG. 2 illustrates a capping machine having capper head 150 for placing a closure 180 on bottle 160. Rotatable star wheel 20 essentially comprises a hub 22 secured to a vertically extending drive shaft 24 which rotates about a drive shaft axis 26.

Extending radially outwardly from hub 22 are a plurality of bottle support assemblies 30. As shown, each of bottle support assemblies 30 is mounted on star wheel 20 at a bottle support station 32. Each of bottle support assemblies 30 is arranged about the periphery 28 of rotatable star wheel 20, which is generally circular. Each bottle support assembly 30 is removable from star wheel 20 through other embodiments, known in the industry.

Rear container guide 40 includes an annular rear neck guide 44 secured in a stationary manner by bolts 46 to a frame member 48. Rear neck guide 44 has a top surface 50, a bottom surface 52 and an inclined edge surface 54 which extends radially outwardly from top surface 50 to bottom surface 52. An annular neck block 56 is secured by fasteners 58 to top surface 50 of rear neck guide 44. Neck block 56 has atop surface 60 which, as shown in FIG. 2, is adapted to be in contact with the underside 172 of anti-rotation flange 170 of bottle 160. Neck block 56 also includes an inclined edge surface 62 extending radially outward from top surface 60. Fixed rear guide 40 and specifically annular neck block 56 functions to support anti-rotation flange 170 and bottle 160 by retaining bottle 160 on rotatable star wheel 20.

Star wheel 20 extends radially outwardly from hub 22 and has an annular neck portion 34 secured at its inner end to hub 22. Specifically, a neck portion top surface 36 extends radially outwardly to a neck portion edge surface 38 which is generally coaxial with drive shaft axis 26. Neck portion edge surface 38 terminates at a support plate portion 70 having a support plate top surface 72 which also extends radially outward from hub 22 and is generally parallel to top surface 36. Support plate top surface 72 extends radially outwardly to a support plate edge surface 74 which then extends downwardly to a ledge plate portion 76 having a ledge plate top surface 78 parallel to both of top surfaces 36 and 72. Top surface 78 extends radially outwardly to periphery 28 of star wheel 20.

As shown, star wheel 20 is used on large capacity bottling machines. This means that periphery 28 is circular and shaft 24 is fitted with a single hub 22 and star wheel 20 can be used with many different sizes of bottles run on the same bottling line. Bottle support assemblies 30 for each size bottle are provided and are also capable of being removed and replaced for different size bottle applications. It will be appreciated that for smaller capacity machines or for different applications within the same bottling line, a star wheel may instead comprise a hub and star wheel portion having individual pockets within the star wheel itself that serve as a function similar to bottle support assembly 30. In such an instance, individual hubs are designed and removable when it is desired to convert a line to different size bottles. It will be appreciated that in this instance, star wheel 20 is split into two halves 20A and 20B to permit installation and repair without disturbing, for instance, capper head 150 shown schematically in FIG. 2, and further to allow ease of assembly and disassembly by reducing the weight of individual pieces. Such difference in a hub does not affect the present invention.

Bottle support assemblies 30 comprise three distinct pieces including a neck support bracket 80, a neck guide 82 and a bottom body guide 84. Neck support bracket 80 is attached to star wheel 20 with neck guide 82 attached to a top surface 86 of neck support bracket 80 and bottom body guide 84 attached to guide support 88 of neck support bracket 80.

Neck guide 82 includes a vertical standard 90 extending upwardly from top surface 86 and a bracket 92 extending perpendicular from vertical standard 90 radially outwardly. Bracket 92 includes a top surface 94, a bottom surface 96 and an inclined edge surface 98 which extends radially outwardly from top surface 94 to bottom surface 96. The top surface includes four openings 100. Anti-rotation plate or bottle support plate 102 is secured to top surface 94 of bracket 92 by hex-screws 104 and pins 106. Anti-rotation plate 102 includes two openings 108 for screws 104 and two openings 110 for pins 106, which are used to secure and position the anti-rotation plate to bracket 92. One or more anti-rotation plates can be removed from bracket 92 and replaced by simply removing the screws. As can be appreciated, other means for connecting the anti-rotation plate to the bracket in a removable or non-removable manner can be used (e.g., bolts, nails, clips, welding, soldering, rivets, adhesive, clamps, and/or the like). In addition, quick connect/disconnect fastening systems known in the industry can be utilized.

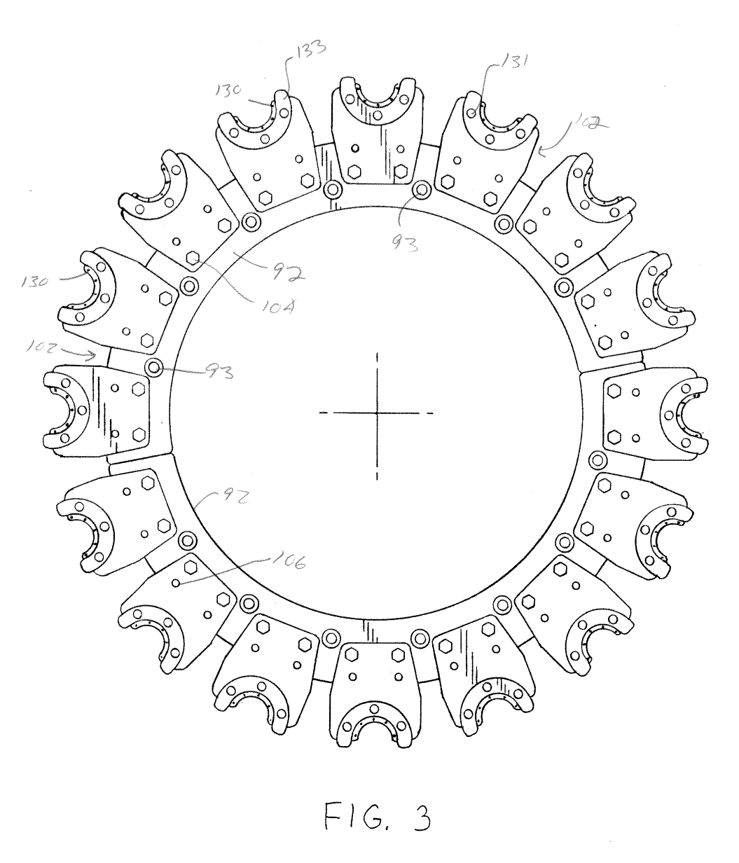

Neck guide 82 includes a vertical standard 90 extending upwardly from top surface 86 and a bracket 92 extending perpendicular from vertical standard 90 radially outwardly. Bracket 92 includes a top surface 94, a bottom surface 96 and an inclined edge surface 98 which extends radially outwardly from top surface 94 to bottom surface 96. The top surface includes four openings 100. Anti-rotation plate or bottle support plate 102 is secured to top surface 94 of bracket 92 by hex-screws 104 and pins 106. Anti-rotation plate 102 includes two openings 108 for screws 104 and two openings 110 for pins 106, which are used to secure and position the anti-rotation plate to bracket 92. One or more anti-rotation plates can be removed from bracket 92 and replaced by simply removing the screws. As can be appreciated, other means for connecting the anti-rotation plate to the bracket in a removable or non-removable manner can be used (e.g., bolts, nails, clips, welding, soldering, rivets, adhesive, clamps, and/or the like). FIG. 3 illustrates that the star wheel is formed of two pieces; however, this is not required. The brackets can be connected to the vertical standard 90 of the neck guide 82 by a plurality of bolts, screws, etc. As illustrated in FIG. 3, the bracket includes bolt holes 93 that can be used to secure the brackets to vertical standard 90.

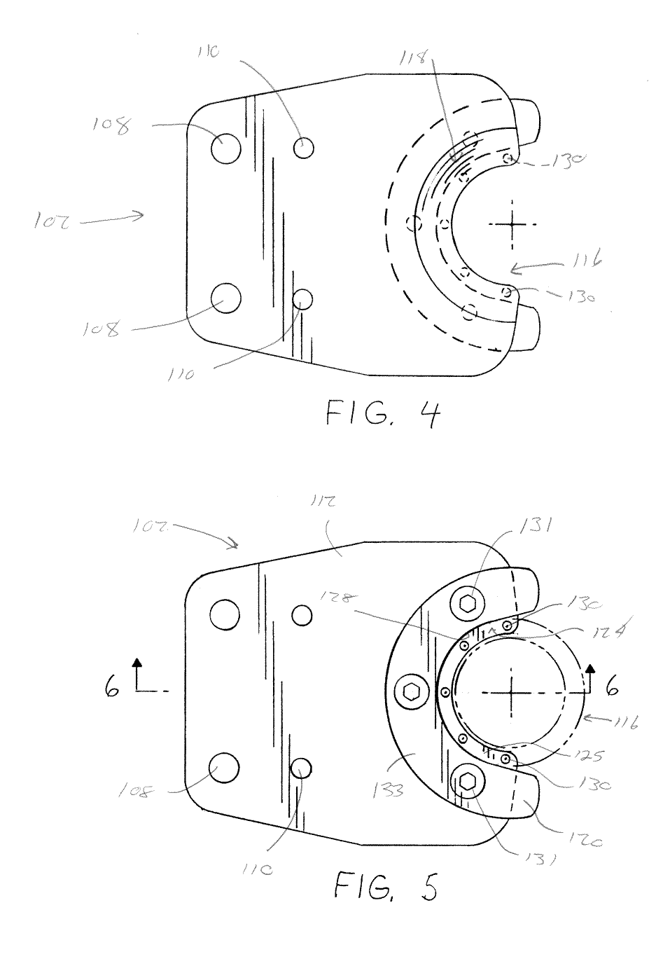

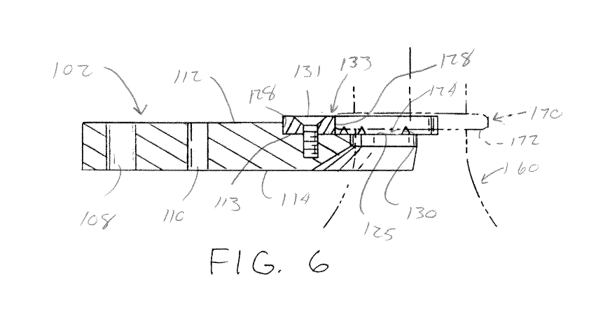

Referring now to FIGS. 4-9, anti-rotation plate 102 has a top surface 112 and a bottom surface 114. Each anti-rotation plate includes a pocket 116 that is adapted to receive a flange 170 of bottle 160. As shown in FIGS. 4 and 5, the width of the anti-rotation plate is greater at the end including the pocket than at the end including openings 108; however, this is not required. The narrowing of the anti-rotation plate at the connection end facilitates connecting and orienting multiple anti-rotation plates on bracket 92. As can be appreciated, other configurations of the anti-rotation plate can be used to facilitate in connecting and orienting multiple anti-rotation plates on bracket 92.

The top surface of the anti-rotation plate includes a recessed region 118 that surrounds pocket 116. The top surface 120 of recessed region 118 generally lies in the same plane as top surface 112. End wall 122 is generally perpendicular to top surfaces 112 and 120. As can be appreciated, end wall 122 can be oriented non-perpendicular to top surface 120. The recessed region provides clearance for capper head 150 during the capping process. As can be appreciated, the recessed region can be eliminated from the anti-rotation plate.

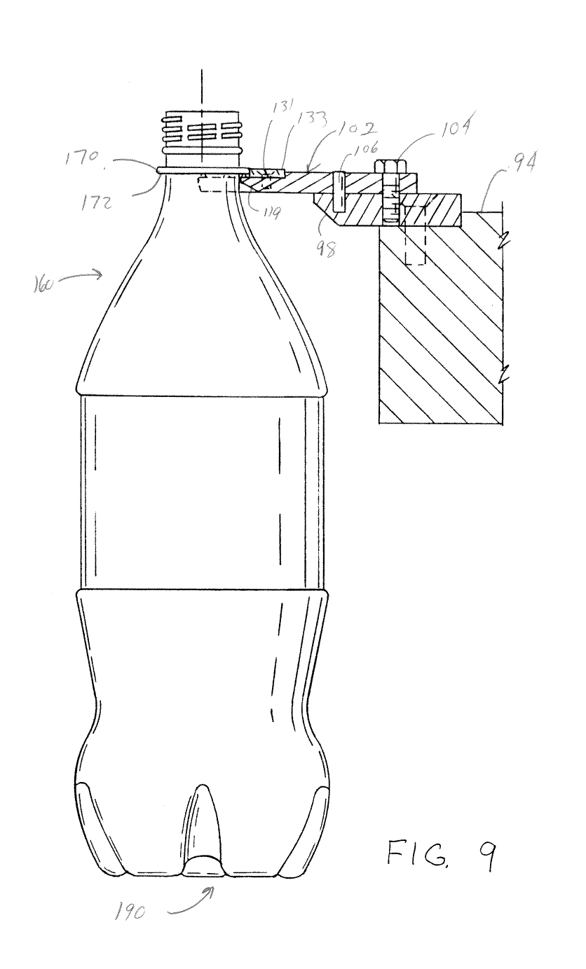

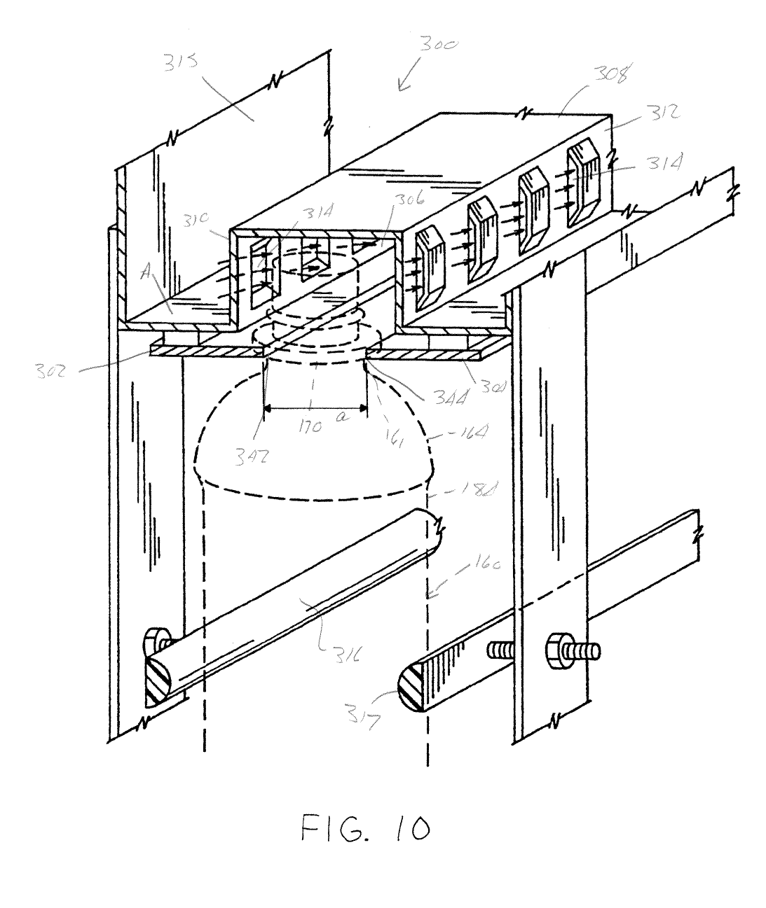

Pocket 116 includes a support ledge 124 that is adapted to partially or fully support bottle 160 during the bottling and/or capping process. As such, deformation and/or damage to the base of the bottle, such as plastic bottles, during the bottling and/or capping process is reduced or eliminated. As illustrated in FIG. 9, bottle 160 can optionally include a pedaloid base configuration 190 that includes a plurality of diverging recesses forming a plurality of legs. The base of bottle 160 can be designed to rest on receiving nests on a standard wear plate; however, this is not required. The wear plate, when used, can have upper surface features that are designed to engage the bottom of the bottle and inhibit or prevent the bottle from rotating during the capping process; however, this is not required. As can be appreciated, the bottle capping machine can be designed such that the bottom or the bottle does not contact a surface during the capping process and/or contacts a surface that is not designed to inhibit or prevent the bottle from rotating during the capping process. During the capping process, the capper exerts a downward force on the bottle when inserting the cap on the bottle. As set forth above, pocket 116 is adapted to partially or fully support bottle 160 during the capping process, thus inhibiting or preventing deformation and/or damage to bottle, such as plastic bottles, during the bottling and/or capping process.

As stated above, the forces necessary to secure the cap can damage plastic bottles. Support ledge 124 includes a top surface 125 which generally lies in the same plane as top surface 112. Support ledge 124 is designed to receive underside 172 of flange 170 of bottle 160. The front face 126 of the support ledge is semi-circular in configuration and encompasses an angle of up to about 180°. The semi-circular configuration of the front face is adapted to receive the circular portion of the neck of the bottle located below the flange; however, the front face does not contact the circular portion of the neck of the bottle located below the flange when the flange is fully positioned in the top surface 125 of the support ledge 124. As can be appreciated, the shape of the front face can be other than semi-circular. Extending upwardly from the support ledge and to the top surface of the recessed region is wall 128. The plane of the wall is generally perpendicular to top surface 120 and support ledge 124. As can be appreciated, the plane of the anti-rotation wall can be oriented so as to form an angle of between about 90-130° between the wall and support ledge 124. The top portion of the wall can abruptly converge with top surface 120 of recessed region 118, or have a smoother transition in the form of a curved surface.

Wall 128 generally has a semi-circular shape so as to receive the circular bottle flange 170. The size and position of wall 128 and support ledge 124 are selected such that when the bottle flange 170 is fully and properly positioned in the support ledge 124 and rests up against wall 128, the neck of the bottle is properly positioned relative to capper head 150 during the capping process so that a cap is properly inserted onto the bottle. The support ledge includes one or more non-smooth surfaces (e.g., ribs, pin points, teeth, etc.) that are designed to inhibit or prevent rotation of bottle 160 when a closure 180 is tightened thereon by capper head 150. As illustrated in FIGS. 3-5, each of the support ledge on the anti-rotation plate includes a plurality of pin points 130 that extend upwardly from the surface of the support ledge. The pin points are illustrated as being spaced at equal distances from one another; however, this is not required. When the capper head 150 presses downwardly on the bottle during the capping process, the bottom surface 172 of the flange of the bottle is forced downwardly onto the one or more non-smooth surfaces, thereby temporarily holding the bottle in position relative to the anti-rotation plate during the capping process. As best illustrated in FIG. 3, four pin points 130 that extend upwardly from the surface of the support ledge; however, it can be appreciated that a larger or smaller number of pin points can be used. The five pin points 130 are illustrated as being spaced approximately equal distances from adjacently positioned pin points; however, this is not required. The pin points have a sharp edge that is deigned to penetrate into the flange of the bottle when the capper head presses down upon the bottle and applies a cap to the bottle. The height of the non-smooth surfaces if less than the height of wall 128. Generally, the height of all of the non-smooth surfaces are to same; however, this is not required. Generally, the ratio of the height of the non-smooth surfaces 130 to the height of wall 128 is about 0.05-0.7:1, typically 0.1-0.5:1, and more typically 0.1-0.3:1.

The pocket of the anti-rotation plate and/or the anti-rotation plate can be made of stainless steel (e.g., 304, 316, etc.); however, it can be appreciated that other or additional materials can be used. Typically the anti-rotation plate is electro-polished; however, this is not required. The thickness of the anti-rotation plate is about 0.1-0.5 inches and generally about 0.1875 inches. As can be appreciated, other thicknesses can be used. Openings 108 have a diameter of about 0.1-0.4 includes and generally about 0.28 inches, and openings 110 have a diameter of about 0.1-0.4 includes and generally about 0.19 inch. As can be appreciated, other shapes and sizes of the openings can be used. The recessed region 118 is recessed about 0.005-0.0.8 inches and generally about 0.016 inch and has a radius of about 0.75-2.5 inches and generally about 1.125 inches. As can be appreciated, other depths of the recess and radii of the recessed region can be used. As can be appreciated, the recess can be eliminated from the anti-rotation plate. The height of wall 122 is about 0.02-0.2 inches and generally about 0.093 inch. As can be appreciated, other heights can be used. The height of the non-smooth surfaces is generally less than the height of wall 122. Typically the average height of the non-smooth surfaces is about 5-80% of the height of wall 122, more typically about 10-50% of the height of wall 122, and even more typically about 10-30% of the height of wall 122. The distance of the center of wall 122 from the center of pocket 116 is about 0.3-0.8 inches and typically about 0.618 inches. As can be appreciated, other distances can be used. The front face 126 of support ledge 124 has a radius of curvature of about 0.655 inch. As can be appreciated, other radii of curvature can be used. The front face of wall 128 has a radius of curvature of about 0.875 inches. As can be appreciated, other radii of curvature can be used.

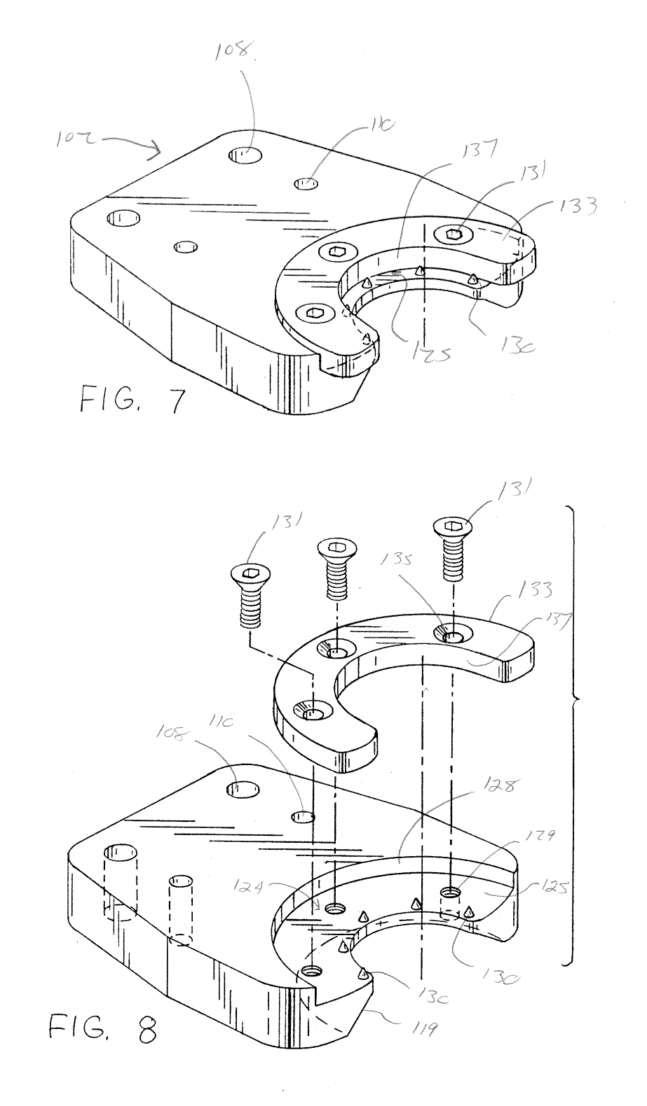

The anti-rotation plate can include a bottle adaptor 133 that can be mounted to support ledge 124 by screws 131 as illustrated in FIGS. 6-8. The bottle adaptor can be used to easily modify the anti-rotation plate to accommodate different sized bottles and/or bottle flanges. The bottle adaptor includes openings 135 that are designed to received screws 131. Top surface 125 of landing 124 also includes openings 127 designed to receive the ends of screws 131 so as to removably connect the bottle adaptor to the anti-rotation plate. The back wall 137 is designed to engage and/or act a stop of the bottle flange when the bottle is positioned on the anti-rotation plate. As illustrated in FIGS. 7 and 8, the bottom surface 114 of the anti-rotation plate can include a sloped surface 119 that facilitates in enabling the bottle to be properly positioned on the anti-rotation plate.

Although not illustrated, the bottle adaptor can be designed to include a landing for the flange and/or one or more non-smooth surfaces 130. The use of the bottle adaptor can be simply removed and replaced instead of the complete anti-rotation flange.

As shown in FIG. 2, bottom body guide 84 includes a body guide bottom surface 85 and a body guide upper surface 87. Bottom body guide 84 is rigidly attached to neck support bracket 80 and specifically to guide support 88. It will be appreciated that each bottom body guide 84 can have a retaining pocket (not shown) having a semi-circular cross section. As such, bottom body guide 84 contacts the sidewall of bottle 160 at an area vertically downward from pocket 116 of anti-rotation plate 102 and at an area diametrically opposed to a sidewall contact established by an annular sidewall rear guide 64 to retain bottle 160 substantially vertical while star wheel 20 rotates bottles 160 from a fixed entry point to fixed exit point 42.

Annular sidewall rear guide 64 has an inner radial surface 65 and an outer surface 66, the radius of each surface 65 and 66 terminating at drive shaft axis 26. Sidewall rear guide 64 includes an upper surface 67 and a lower surface 68. A through-sleeve extends between upper surface 67 and lower surface 68 at least one location in sidewall rear guide 64. It will be appreciated that the relative size and relationship of rear guide 64 can remain generally constant for many size bottles since, for instance, the diameter of a one-liter, a 12-ounce and a 20-ounce bottle are generally the same. It will also be appreciated that the that rear guide 64 can be completely changed out and replaced with a different size rear guide 64. Suspended from rear neck guide 44 is at least one vertical post or positioning rod 69. The positioning rod can include circumferential concave grooves (not shown) spaced along a length between the lower end and an upper end of the vertical post. Vertical post 69 is attached to rear neck guide 44 by the hex head bolts 46. Sidewall rear guide 64 can be attached to vertical post 69 by various means. One such arrangement is disclosed in U.S. Pat. No. 5,732,528, which is fully incorporated herein by reference.

Referring now to FIGS. 2 and 9, bottle 160 is in the form of a beverage bottle. Bottle 160 includes an upper neck and mouth-forming portion 162, a cylindrical sidewall portion 184 extending around the longitudinal axis of the container, and a lower base-forming portion 190. The upper neck and mouth-forming portion 162 provides a neck-forming transition 164 leading to the container mouth 166. The transition portion 164 can take any conveniently usable and moldable shape such as, but not limited to, a frustoconical shape, hemispherical shape, ogive shape, or some other shape. A thread 168 positioned adjacent mouth 166 is designed to accept a threaded cap 180 commonly used to close the beverage bottles; however, the mouth-forming portion of the containers can be provided with means to accommodate other types of closures.

The upper neck and mouth-forming portion 162 also includes a flange 170 positioned above the transition portion 164. The flange includes an underside surface 172 and a topside surface 174. Underside surface 172 is adapted to be partially or fully supported in pocket 116 of anti-rotation plate during the capping process. Underside surface 172 is also adapted to be partially or fully supported by guide rails 140, 142 when the bottle is being conveyed to and/or from the bottling and/or capping apparatus as illustrated in FIG. 2.

As shown in FIG. 9, lower base-forming portion 190 of container 160 includes a plurality of foot-forming portions formed about the central portion for supporting bottle 160. As can be appreciated, the lower base-forming portion can have other shapes (e.g., a hemispherical or champagne-type configuration, etc.).

The bottle can be formed into a variety of dimensions to satisfy a particular use. Typically, the bottle is sized for 16-ounce applications, 20-ounce applications, one-quart applications, one-liter applications, two-quart applications, two-liter applications, and one-gallon applications. As can be appreciated, other sized bottles can be used. For instance, a bottle for containing 20 ounces can have an overall height of about 7-9 inches, for filling within about 1.25-2 inches of the mouth. When the bottle is a plastic bottle, the upper neck and mouth-forming portion can be finished with a threaded opening (e.g., PCO-28 finish). As can be appreciated, a sports top that allows for easy opening and closing of the mouth can be additionally or alternatively inserted in the mouth of the bottle. The cylindrical sidewall of the bottle can have a maximum diameter of about 2.25-3.5 inches. A reduced label panel diameter 193 on the sidewall can be optionally used. If such panel diameter is used, the diameter can be about 2-3.25 inches. Additionally and/or alternatively, the sidewall can include one or more ribs 194 extending about the central axis of the bottle. A number of other configurations can be incorporated on the sidewall for structural and/or aesthetic purposes. The neck-forming transition between the cylindrical sidewall and the mouth can be an ogive shape extending downwardly from about 0.5-1.5 inches below the mouth of to blend into the cylindrical sidewall approximately 2-3.5 inches below the mouth. The base of the bottle can be substantially flat, convex, and/or include a plurality of feet or legs. If the bottle is a plastic bottle that includes feet or legs, such configuration can be the same or similar to configurations disclosed in U.S. Pat. Nos. 4,978,015; 5,603,423; and 6,276,546, which are fully incorporated herein by reference.

In another example, a bottle for containing two liters can have an overall height of about 10-13 inches, for filling within about 1-2.25 inches of the mouth. The finish of the bottle, when made of plastic, can be a threaded opening with a PCO-28 finish. The cylindrical sidewall of the improved bottle can have a maximum diameter of about 3.5-5 inches. A reduced label panel diameter on the sidewall can be used. If such panel diameter is used, the diameter can be about 3.25-4.75 inches. Additionally, and/or alternatively, the sidewall can include one or more ribs extending about the central axis of the bottle. A number of other configurations can be incorporated on the sidewall for structural and/or aesthetic purposes. The neck-forming transition between the cylindrical sidewall and the mouth can be an ogive shape extending downwardly from about 0.5-1.5 inches below the mouth to blend into the cylindrical sidewall approximately 3-5 inches below the mouth. The base of the bottle can be substantially flat, convex, and/or include a plurality of feet or legs. If the improved plastic container includes feet or legs, such configuration can be the same or similar to configurations disclosed above.

Bottle 160 can be formed by a number of standard techniques. Typically, when the bottle is formed of plastic, the bottle is formed from PET; however, other plastics can be used. Generally, the processing of the plastic bottle involves the injection molding of PET into what is commonly referred to as a “preform” and then blow-molding such preform into the improved plastic container. The bottle, when formed of plastic, can be formed by a conventional injection-molded preform. As known in the art, various configurations of preforms for a desired plastic bottle can be used to make various plastic bottle designs. The use of a particular preform with a particular plastic bottle design is a matter of design and the selection criteria. It may be advantageous to alter the design of the preform to optimize the final plastic bottle design. For instance, it may be advantageous to taper the bottom of the preform to allow better orientation and distribution of material. As can be appreciated, other alterations can be used. The improved plastic container can be formed by a conventional stretch blow-molding process.

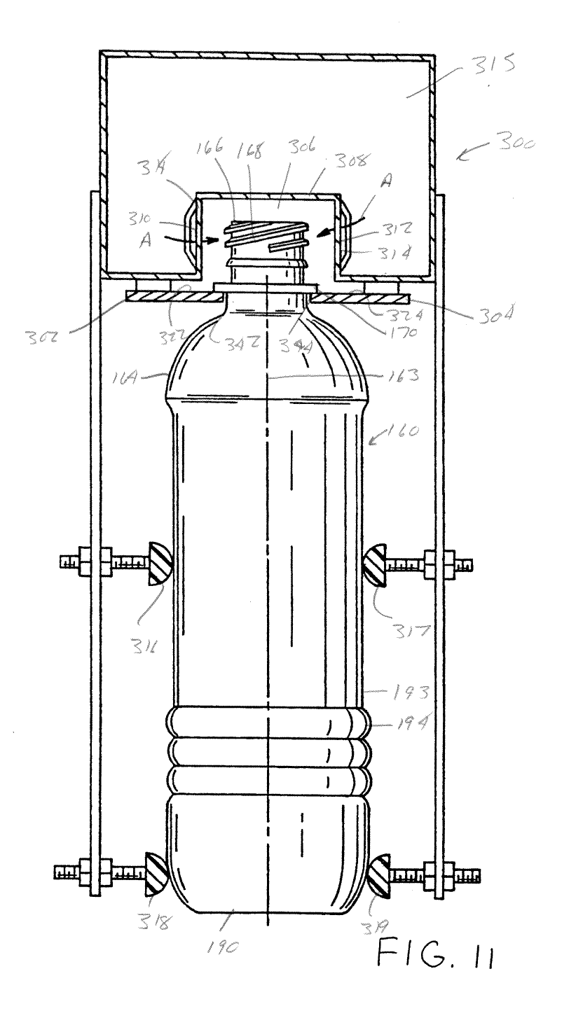

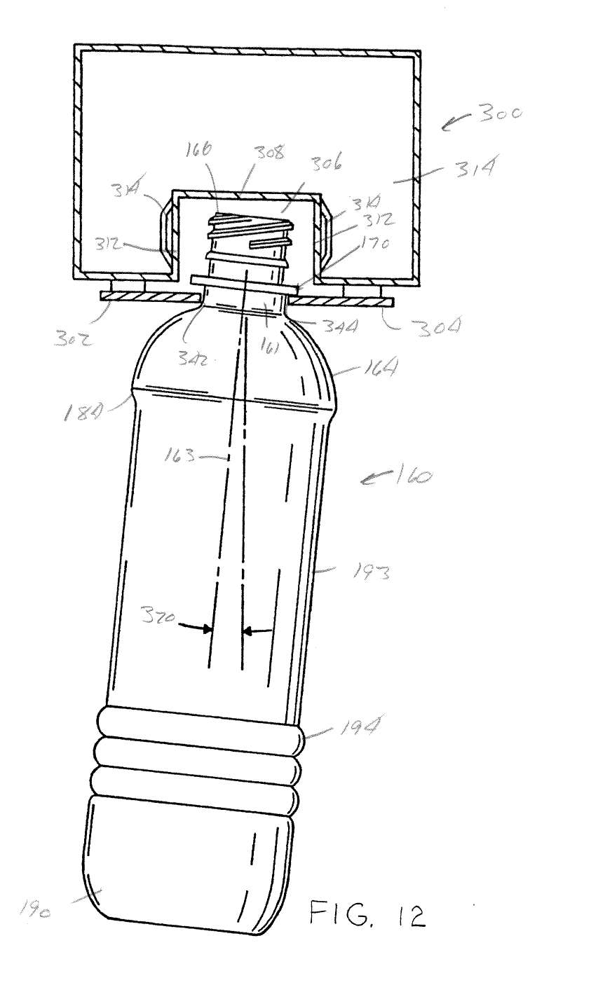

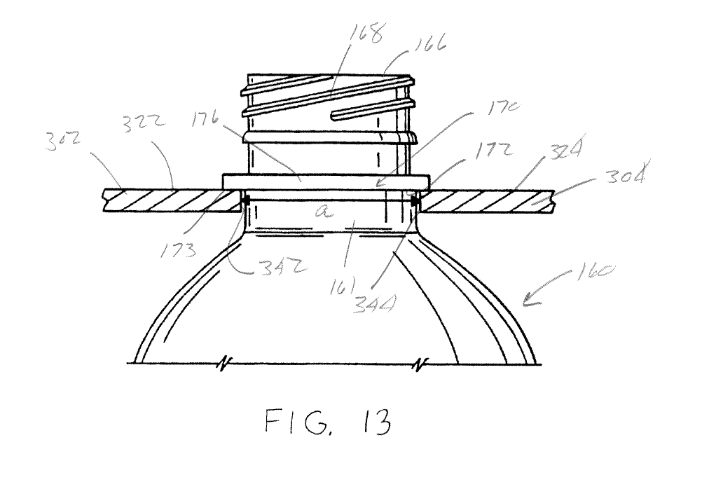

Referring now to FIGS. 10-13, an air-powered conveyor system 300 is shown. Air-powered conveying systems are known in the art and are shown in U.S. Pat. Nos. 4,284,370; 5,161,919; and, 5,437,521 which have been fully incorporated by reference herein as background information. In general terms, air-powered conveyor 300 includes inwardly extending track rails 302 and 304 which support and guide bottle 160 as it moves along the conveying system. Rails 302 each have an inner edge 342 and 344 that face one another and are spaced from one another a distance “a” along the majority of the length of the conveyor system. Distance “a” is preferably approximately 1.060 inches to provide unrestricted passage of neck 161 of bottle 160 that has a neck diameter approximately equal to 1.030 inches. As can be appreciated, distance “a” can have different values for different sized necks. The difference between the neck diameter and distance “a”, also allows for variations in both the rails and the neck of one bottle to the next. But distance “a,” is sufficiently small to prevent the passage of flange 170 thereby supporting the bottle by the flange. As will be appreciated, even though only one bottle is shown, the conveying system would include numerous bottles front to back to one another during the filling operations. Air conveyor 300 further includes an elongate plenum chamber 315 having an air conveying channel 306 formed by a top wall 308 and side walls 310, 312. Both side walls 310, 312 include a plurality of air conveying slots 314 lying in a row along the length of the side walls. These side walls transfer the air from the plenum chamber to air channel 306 and into contact with bottle 160 thereby moving the bottle in the direction of the flowing air. Pressurized air A is applied and flows as is shown in FIG. 11 to move the bottles. Conveyor 300 further includes guides 316-319 which help maintain bottle 160 in the proper orientation relative to rails 302 and 304. As can be appreciated, maintaining a proper alignment between the bottle and the conveying system is important to minimize the chance of a bottle becoming dislodged from the conveying system or jammed in the conveying system. If angle 319 becomes excessive, bottle 160 can become jammed or can fall from the rails. Furthermore, if the bottle rotates relative to track rails 302, 304 about bottle axis 163, a polygonal flange can disengage from rails 302 and 304 which will be discussed in greater detail below. As can be further appreciated, modifications to the track rails of the conveying system can be costly in both downtime to the bottling process and the labor involved in making the modifications which makes it advantageous to minimize the modifications when a new bottle is used.

The configuration of a flange determines how well the flange will be maintained by the rails of the conveying system. Flange 170 provides the benefits discussed above in relation to the capping process and also works in connection with existing conveying systems without modifications. In fact, flange 170 minimizes the chances of bottle 160 becoming jammed or dislodged from rails 302 and 304 even during bottle rotation about the bottle axis and/or bottle canting about the bottle axis.

To help reduce bottle canting, bottom surface 172 of flange 170 includes a flat surface portion 173 that is perpendicular to bottle axis 163 thereby creating additional stability of bottle 160 relative to rails 302, 304. Surface portion 173 can be some or virtually all of bottom surface 172. In this respect, by including a flat bottom surface portion 173 that engages the conveyor rails, bottle 160 is better maintained in a vertical position relative to the upper surface of the rails and is more stable as it moves along the rails. In this respect, rails 302 and 304 have upwardly facing surfaces 322 and 324 respectively. Surfaces 322 and 324 are coplanar and are perpendicular to the desired orientation of bottle axis 163. Accordingly, by including flat bottom surface portion 173, bottle 160 is better maintained in the proper orientation. As is stated above, this surface can be some or all of bottom surface 172. For example, flat portion 173 can be spaced at least 0.005 inches from bottle neck 161 of bottle 160. In another example, flat portion 173 can be spaced at least 0.025 inches from the bottle neck. Turning to top surface 174, there is no need for this surface to be perpendicular to bottle axis 163. In fact, it is preferred that top surface 174 be non-parallel to bottom surface 172 by an angle 330. Generally, angle 330 is less than 5°.

The present invention has been described with reference to a number of different embodiments. It is to be understood that the invention is not limited to the exact details of construction, operation, exact materials or embodiments shown and described, as obvious modifications and equivalents will be apparent to one skilled in the art. It is believed that many modifications and alterations to the embodiments disclosed will readily suggest themselves to those skilled in the art upon reading and understanding the detailed description of the invention. It is intended to include all such modifications and alterations insofar as they come within the scope of the present invention.

I claim:

1. A bottle support plate for use in a rotary capping machine to apply caps onto the upper threaded neck of one or more containers having a circular flange as the containers are moved along a generally circular path by a star wheel, said bottle support plate including a pocket that at least partially supports and at least partially mates with the flange of the container to at least partially inhibit rotation of the container during the threading of a cap on an upper threaded neck of the container, said pocket including a support ledge having an upper surface, a neck cavity, a removable bottle adaptor having a ledge wall extending upwardly from said upper surface of said support ledge when said bottle adaptor is connected to said bottle support plate, and a non-smooth surface on an upper surface of said support ledge, said ledge wall of said bottle adaptor having a curvilinear face designed to be at least partially mateable with at least a portion of an outer peripheral edge of the flange of said container, said neck cavity designed to receive a portion of a neck of the container that is located below the container flange, said neck cavity designed to be spaced from the neck of the container when a bottom surface of the flange of the container is positioned on or above said upper surface of said support ledge and the portion of the outer peripheral edge of the flange is in contact with said ledge wall, said non-smooth surface designed to engage a portion of the bottom surface of the bottle flange and inhibit or prevent rotation of the bottle when a cap is twisted onto the upper threaded neck of the container.

2. The bottle support plate as defined in claim 1, wherein said neck cavity includes a curvilinear shaped front surface, said ledge wall having a front surface that is shaped similarly to said neck cavity, said neck cavity having a smaller radius of curvature than said ledge wall.

3. The bottle support plate as defined in claim 1, wherein at least a portion of a front face of said ledge wall forms an angle with said support ledge of at least about 90°.

4. The bottle support plate as defined in claim 1, wherein said non-smooth surface is a pin point or sharp edge that is designed to at least partially penetrate into the bottom surface of the container flange during a capping process.

5. The bottle support plate as defined in claim 1, wherein said bottle support plate is removably connected to said star wheel.

6. The bottle support plate as defined in claim 1, wherein said bottle support plate includes at least one mount opening used to connect said bottle support plate to said star wheel and at least one positioning opening to orient said bottle support plate on said star wheel.

7. The bottle support plate as defined in claim 1, wherein atop surface of said bottle support plate includes a recessed portion that terminates at said ledge wall.

8. A method of inhibiting rotation of a container of the type having an upper threaded neck and a circular flange as a capping head screws a cap onto said neck, said method comprising:
providing a bottle support plate that includes a pocket designed to at least partially support and at least partially mate with the flange of the container so as to at least partially inhibit rotation of the container during the threading of a cap on an upper threaded neck of the container, said pocket including a support ledge having an upper surface, a neck cavity, a ledge wall extending upwardly from said upper surface of said support ledge and a non-smooth surface on an upper surface of said support ledge, said wall having a curvilinear face designed to be at least partially mateable with at least a portion of an outer peripheral edge of the flange of said container, said neck cavity designed to receive a portion of a neck of the container that is located below the container flange, said neck cavity designed to be spaced from the neck of the container when a bottom surface of the flange of the container is positioned on or above said upper surface of said support ledge and a portion of the outer peripheral edge of the flange is in contact with said ledge wall, said non-smooth surface designed to engage a portion of the bottom surface of the bottle flange and inhibit or prevent rotation of the bottle when a cap is twisted onto the upper threaded neck of the container;
moving said container into said pocket such that a bottom surface of said flange of said container at least partially engages, and is at least partially supported by a support ledge of said pocket, said support ledge at least partially countering a downward force applied to the upper threaded neck of said container during the threading of a cap on said upper threaded neck of said container; and,
applying a cap to said an upper threaded neck, said cap creating a downward force on the bottle which is at least partially counter by said support plate, said non-smooth surface on said support plate frictionally engaging the bottom surface of the flange to thereby inhibit or prevent rotation of the bottle when said cap is twisted onto the upper threaded neck of the container.

9. The method as defined in claim 8, wherein said neck cavity includes a curvilinear shaped front surface, said ledge wall having a front surface that is shaped similarly to said neck cavity, said neck cavity having a smaller radius of curvature than said ledge wall.

10. The method as defined in claim 8, wherein at least a portion of a front face of said ledge wall forms an angle with said support ledge of at least about 90°.

11. The method as defined in claim 8, wherein said non-smooth surface is a pin point or sharp edge that is designed to at least partially penetrate into the bottom surface of the container flange.

12. The method as defined in claim 8, wherein said bottle support plate is removably connected to said star wheel.

13. The method as defined in claim 8, wherein said bottle support plate includes at least one mount opening used to connect said bottle support plate to said star wheel and at least one positioning opening to orient said bottle support plate on said star wheel.

14. The method as defined in claim 8, wherein a top surface of said bottle support plate includes a recessed portion that terminates at said ledge wall.

15. An improved rotatable star wheel for a bottling machine for tilling and/or capping containers having an upper threaded neck and a non-filly circular flange, said star wheel for moving said containers through said machine, said star wheel comprising at least one bottle support plate, said bottle support plate including a pocket that at least partially supports and at least partially mates with the flange of the container to at least partially inhibit rotation of the container during the threading of a cap on an upper threaded neck of the container, said pocket including a support ledge having an upper surface, a neck cavity, a ledge wall extending upwardly from said upper surface of said support ledge and a non-smooth surface on an upper surface of said support ledge, said wall having a curvilinear face designed to be at least partially mateable with at least a portion of an outer peripheral edge of the flange of said container, said neck cavity designed to receive a portion of a neck of the container that is located below the container flange, said neck cavity designed to be spaced from the neck of the container when a bottom surface of the flange of the container is positioned on or above said upper surface of said support ledge and the a portion of the outer peripheral edge of the flange is in contact with said ledge wall, said non-smooth surface designed to engage a portion of the bottom surface of the bottle flange and inhibit or prevent rotation of the bottle when a cap is twisted onto the upper threaded neck of the container.

16. The improved rotatable star wheel as defined in claim 15, wherein said neck cavity includes a curvilinear shaped front surface, said ledge wall having a front surface that is shaped similarly to said neck cavity, said neck cavity having a smaller radius of curvature than said ledge wall.

17. The improved rotatable star wheel as defined in claim 15, wherein at least a portion of a front face of said ledge wall forms an angle with said support ledge of at least about 90°.

18. The improved rotatable star wheel as defined in claim 15, wherein said non-smooth surface is a pin point or sharp edge that is designed to at least partially penetrate into the bottom surface of the container flange.

19. The improved rotatable star wheel as defined in claim 15, wherein said bottle support plate is removably connected to said star wheel.

20. The improved rotatable star wheel as defined in claim 15, wherein said bottle support plate includes at least one mount opening used to connect said bottle support plate to said star wheel and at least one positioning opening to orient said bottle support plate on said star wheel.

21. The improved rotatable star wheel as defined in claim 15, wherein a top surface of said bottle support plate includes a recessed portion that terminates at said ledge wall.
